(19) United States
(12) Patent Application Publication
(10) Pub. No.: US 2010/0065000 A1
(43) Pub. Date: Mar. 18, 2010

(54) IGNITION DEVICE FOR AN INTERNAL COMBUSTION ENGINE

(76) Inventors: Werner Herden, Gerlingen (DE); Manfred Vogel, Ditzingen (DE); Heiko Ridderbusch, Schwieberdingen (DE)

Correspondence Address: KENYON & KENYON LLP, ONE BROADWAY, NEW YORK, NY, 10004, US

(21) Appl. No.: 12/305,181

(22) PCT Filed: Aug. 8, 2007
(86) PCT No.: PCT/EP2007/058222

§ 371 Date: Jul. 8, 2009

(30) Foreign Application Priority Data
Aug. 22, 2006 (DE) 102003039393.7

(51) Int. Cl. F02B 19/00

(52) U.S. Cl. 123/143 B

(57) ABSTRACT

An ignition device for an internal combustion engine, particularly of a motor vehicle, having a laser device which has a laser-active solid and which generates a laser beam, preferably in the form of a laser pulse, for eradiation into a combustion chamber, focusing optics for focusing the laser beam being allocated to the laser device. The laser beam has a beam profile that deviates from being circular. A pumping light source is provided for applying pumping light to the laser device. The beam profile of the laser beam and/or of the pumping light is rectangular or linear and/or circular and/or dumbbell-shaped.

### BACKGROUND INFORMATION

The present invention relates to an ignition device for an internal combustion engine, particularly of a motor vehicle, having a laser device which has a laser-active solid and a laser beam, preferably in the form of a laser pulse, for eradiation into a combustion chamber, focusing optics for focusing the laser beam being allocated to the laser device.

An ignition device of this type is described in German Patent Application No. DE 10 2004 001 554 A1.

### SUMMARY

It is an object of the present invention to further develop an ignition device described above, in such a way that it has a simplified design and, at the same time, greater operating safety and efficiency during the ignition of an air/fuel mixture.

This object may be attained, according to the present invention, by using a laser beam for an ignition device having a beam profile that departs from a circular shape.

The beam profile of the laser beam eradiated into the combustion chamber, according to an example embodiment of the present invention, that is not developed in a circular shape, at a given wavelength of the laser beam and a given focal length of the focusing optics makes possible a reduction of the focal diameter of the laser beam, and with that, a higher energy density at an ignition point onto which the laser beam is focused, whereby the reliability during the ignition of an air/fuel mixture, in the combustion chamber of the internal combustion engine, is raised, without having to increase the power of the laser beam, or the energy of a corresponding laser pulse.

Furthermore, it is very advantageous if a pumping light source is provided for applying pumping light to the laser device, the pumping light supplied to the laser device having a beam profile that deviates from circular shape. Such a noncircular beam profile of the pumping light may lead to an also noncircular beam profile of the laser beam generated by the laser device, if the laser device is pumped optically using pumping light that has a noncircular beam profile.

It is further especially advantageous if the beam profile of the laser beam and/or the pumping light has a rectangular shape or a line shape and/or an annular shape and/or a dumbbell shape. In particular, a linear or rectangular beam profile makes possible, quite especially advantageously, the use of optical elements such as the pumping light source or the laser-active solid, which also have a rectangular cross section, whereby, in the case of these elements, one may do without more complex cylindrical structures which, on the one hand, leads to lower production costs and, on the other hand, makes possible more efficient cooling of the respective elements.

One may advantageously provide a light conducting device for supplying the laser device with pumping light provided by a pumping light source, the light conducting device having a plurality of light conducting fibers which, on the one hand, make possible the transmission of a comparatively high pumping power and, by contrast to a single fiber, with respect to its shape, especially in the end regions, is particularly well adaptable to the special geometry of a pumping light source of the laser device.

It is especially preferred if the ends of the plurality of light conducting fibers allocated to the laser device are situated with respect to one another as a function of a specifiable beam profile for the laser beam and/or the pumping light, whereby it is possible to couple pumping light, provided by a usual pumping light source, which is coupled at the input end into a plurality of light conducting fibers, into the laser device corresponding to a desired beam profile. For example, by appropriately positioning the ends of different light conducting fibers one behind another, a linear or rectangular beam profile may be achieved, although the pumping light source, that is doing the feeding, has a usual circular beam profile. In reverse, a pumping light having a linear beam cross section is able to be transformed into a beam cross section having a circular or another shape, because of the positioning of the fiber ends, according to an example embodiment of the present invention.

Because of the use of the plurality of light conducting fibers according to the example embodiment of the present invention, almost any combination is thus achievable for the beam profile of the pumping light. Since the beam profile of the pumping light may also have an effect on the beam profile of a laser beam created as a result of the application using this pumping light, the beam profile of the laser beam generated by the laser device may accordingly also be formed by the use, according to an example embodiment of the present invention, of the plurality of light conducting fibers and the special positioning of their end sections.

The several light conducting fibers of the light conducting device, according to the example embodiment of the present invention, may be combined, at least section-by-section, to form a round cable and/or a flat cable, and thereby permit an optimal configurability of the light conducting device, which may be improved even more if light conducting fibers are used that have a circular or elliptical cross section.

A pumping light source may also be provided especially advantageously, which has a plurality of pumping light emitters, whereby a higher pumping power can be provided, by contrast to using a single pumping light emitter. One or more pumping light emitters are allocated in each case to one light conducting fiber, which couple their pumping light into the respective light conducting fiber, according to an example embodiment of the present invention.

A linear or a matrix-shaped arrangement of the plurality of pumping light emitters is very expedient, so that, especially in the case of the design of the light conducting device as a flat ribbon cable, the geometries of the pumping light source and the cable are adapted to one another, and consequently, no further loss-encumbered elements have to be provided in order to implement the optical connection of the pumping light source to the light conducting device.

An efficient coupling of pumping light into the light conducting device by the reduction in the fast axis divergence may be achieved, for instance, by positioning a cylindrical lens, especially a nonspherical cylindrical lens, between the pumping light source and the light conducting device.

In the case of applications in the motor vehicle field, although the pumping light source is preferably situated at a distance from the laser device, which is usually situated close to the combustion chamber, and is connected to it via the light conducting device that was described, it may also be advantageously provided that the pumping light source is allocated directly on the input side to the laser device or the laser-active solid, and that the pumping light source has a plurality of pumping light emitters, and that the single pumping light emitters themselves are arranged relative to one another as a function of a specifiable beam profile for the laser beam and/or the pumping light. This means that, in this variant of the present invention, the application of pumping light having a noncircular beam profile to the laser device is accomplished directly by the positioning of the single pumping light emitters relative to one another.

Additional features, possible uses and advantages of the present invention are derived from the following description of exemplary embodiments of the present invention, which are illustrated in the figures. All of the features described or illustrated constitute the subject matter of the present invention either alone or in any combination, regardless of the way they are combined, and regardless of their representation in the description or their illustration in the figures.

### BRIEF DESCRIPTION OF THE DRAWINGS

FIG. 1 shows a schematic illustration of an internal combustion engine having an ignition device according to an example embodiment of the present invention.

FIG. 2 shows a schematic representation of the ignition device in FIG. 1.

FIG. 3 shows an enlarged representation of a laser device of the ignition device in FIG. 2.

FIG. 4a shows a top view onto the laser device in FIG. 3, in detail.

FIG. 4b shows a side view of the laser device in FIG. 3.

FIGS. 5a to 5d show details of a pumping light source of the example ignition device according to the present invention.

FIGS. 6a to 6c show various beam profiles for pumping light that are achievable by the positioning of light conducting elements according to an example embodiment of the present invention.

### DETAILED DESCRIPTION OF EXAMPLE EMBODIMENTS

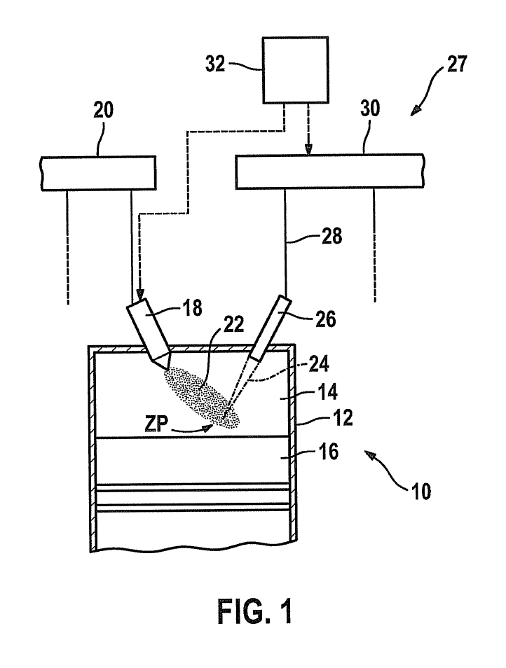

In FIG. 1, an internal combustion engine in its entirety bears reference numeral 10. It is used for driving a motor vehicle that is not shown. Internal combustion engine 10 includes a plurality of cylinders, of which only one, having a reference numeral 12, is shown in FIG. 1. A combustion chamber 14 of cylinder 12 is bounded by a piston 16. Fuel reaches combustion chamber 14 directly through an injector 18, which is connected to a fuel pressure reservoir 20 that is also designated as a rail.

Fuel 22 injected into combustion chamber 14 is ignited using a laser beam 24, which is preferably eradiated, in the form of a laser pulse, into combustion chamber 14 by an ignition device 27 that includes a laser device 26. For this purpose, laser device 26 is fed, via a light conducting device 28, with a pumping light that is provided by a pumping light source 30. Pumping light source 30 is controlled by a control unit 32, which also activates injector 18.

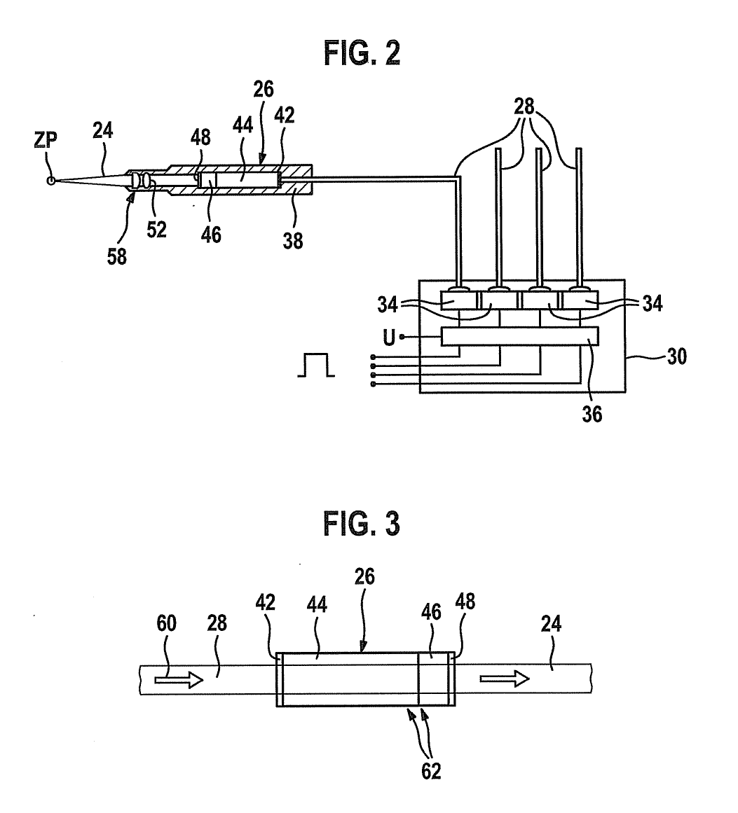

As may be seen in FIG. 2, pumping light source 30 feeds a plurality of light conducting devices 28 for various laser devices 26, which are allocated to different cylinders of internal combustion engine 10, respectively. For this purpose, pumping light source 30 has available to it altogether a plurality of single pumping light sources 34, which are each connected to a pulse current supply 36.

Laser device 26 includes a housing 38 and also has a laser-active solid 44, as well as a passive Q-switch 46 which, together with a coupling mirror 42 and an output mirror 48 form a laser oscillator. Focusing optics 52 situated in FIG. 2 to the left of output mirror 48 is used to focus one of laser beams 24 or laser pulse generated by laser device 26 on an ignition point ZP shown schematically in FIG. 2, which is situated on the other side of combustion chamber window 58 in combustion chamber 14 (FIG. 1) of internal combustion engine 10.

A detailed representation of laser device 26 is indicated in FIG. 3. The basic method of functioning of laser device 26 is the following: Pumping light 60, which is supplied to laser device 26 via light conducting device 28, enters laser-active solid 44 through coupling mirror 42 that is transparent to a wavelength of pumping light 60. Pumping light 60 is absorbed there, which leads to a population inversion. The high losses of passive Q-switch 46 first of all prevent a laser oscillation in laser device 26. However, with increasing pumping duration, the radiation density also rises on the inside of resonator 62, that is formed by laser-active solid 44 and passive Q-switch 46, as well as mirrors 42, 48. Beginning at a certain radiation density, passive Q-switch 46 or a saturable absorber of passive Q-switch 46 fades out, so that a laser oscillation comes about in resonator 62.

Because of this mechanism, a laser beam 24 in the form of a giant pulse is generated, which passes through output mirror 48 and is focused by focusing optics 52 (FIG. 2) on ignition point ZP that is located in combustion chamber 14.

Laser beam 24 has a beam profile that deviates from being circular, according to the present invention. At a given wavelength of laser beam 24 and at a given focal length of focusing optics 52, since the focus diameter of laser beam 24 at ignition point ZP depends only on the diameter of laser beam 24 before focusing optics 52, in particular, is inversely proportional to it, because of the use of a noncircular beam profile, there comes about particularly advantageously a reduction in the focal diameter, and with that, an increase in the radiation density at ignition point ZP, whereby an air/fuel mixture located in combustion chamber 14 is able to be ignited more reliably in response to equal power.

By contrast to a usual circular beam profile of laser beam 24, at least some components of laser beam 24 according to an example embodiment of the present invention are at a greater distance from the optical axis of focusing optics 52, based on the noncircular beam profile, than is the case in usual systems, so that the corresponding reduction in the focal diameter advantageously comes about.

The noncircular beam profile of laser beam 24, according to the present invention, may be implemented, according to an example embodiment of the present invention, for instance, via a special supplying of laser device 26 using pumping light 60. The feeding of laser device 26 using pumping light 60, which itself has a noncircular beam profile, leads to a beam profile of resulting laser beam 24 or laser pulse, which is comparable to the beam profile of pumping light 60, that is, it also has a noncircular beam profile.

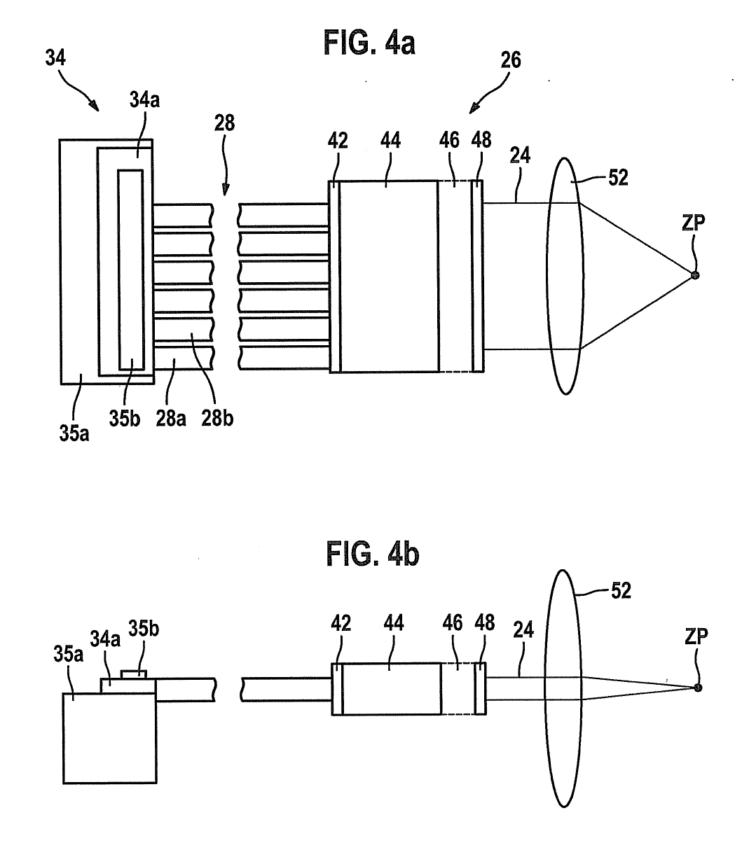

A device, according to the present invention, for generating such an “abnormal” beam profile for laser beam 24 is shown in FIG. 4a, in a top view, and in FIG. 4b in a corresponding side view.

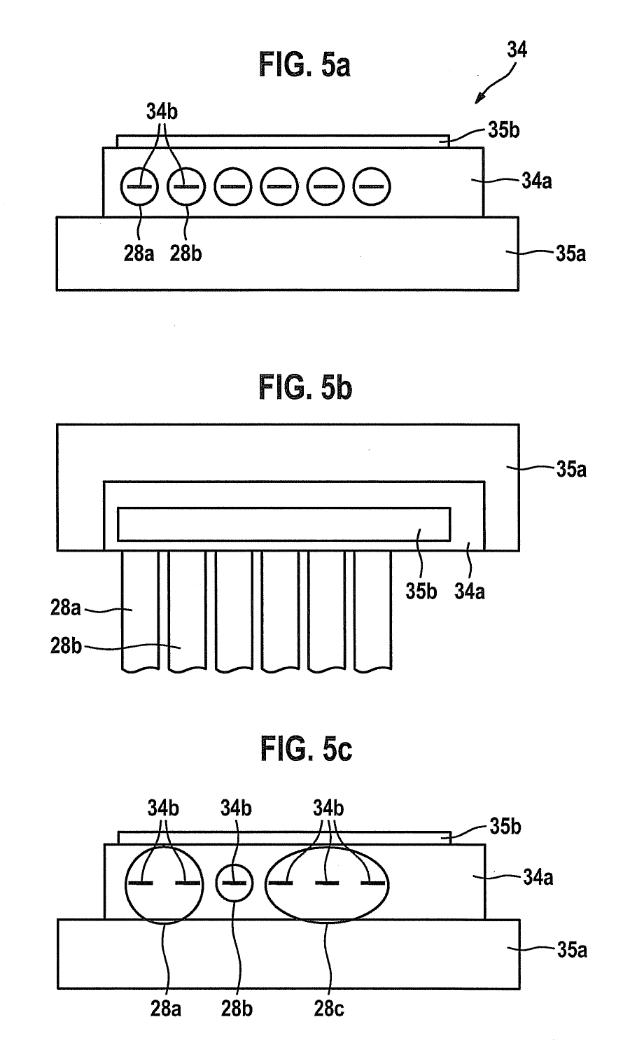

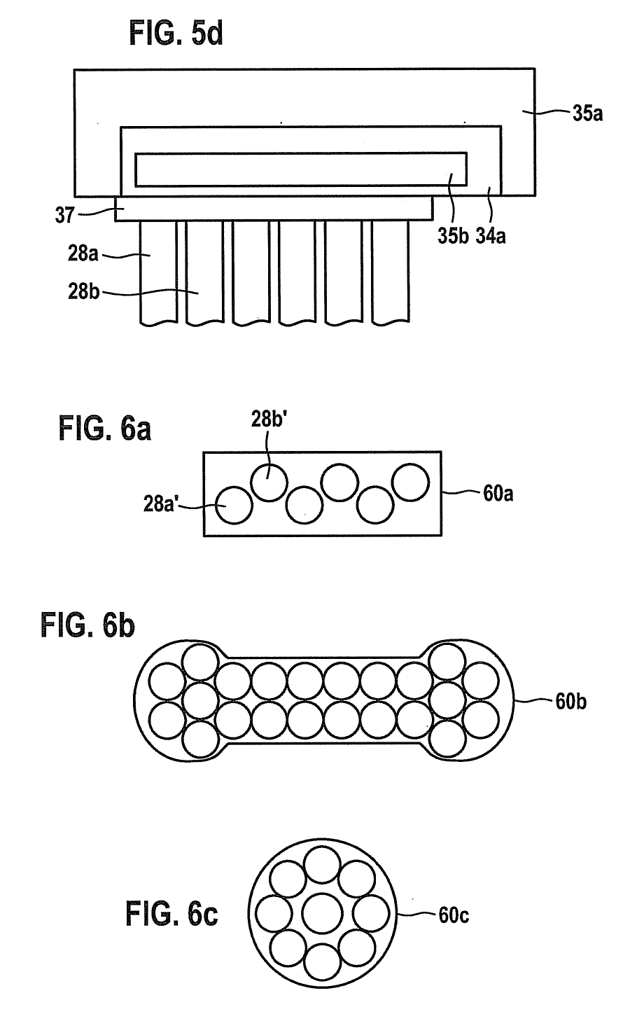

As may be seen in FIG. 4a, a single pumping light source 34 that is allocated to laser device 26 has a so-called semiconductor laser solid body 34a which has a plurality of pumping light emitters 34b, compare 5a. Pumping light emitters 34b of semiconductor laser solid body 34a are positioned along an imaginary line that runs horizontally in FIG. 5a. In FIG. 5a, below semiconductor laser solid body 34a, a cooling device 35a is indicated, and above semiconductor laser solid body 34a a contacting element 35b is provided, which connects semiconductor laser solid body 34a to pulse current supply 36 shown in FIG. 2.

Because of the rectangular cross sectional form of semiconductor laser solid body 34a, it is able to be cooled particularly efficiently, which has a positive effect on the wavelength stability of pumping light emitters 34b, and with that, also on the reliability during generation of laser pulse 24 by laser device 26. Assembly and handling during production are also simplified by the rectangular cross section form of semiconductor laser solid body 34a.

According to an example embodiment of the present invention, light conducting device 28 (FIG. 4a), via which laser device 26 is supplied with pumping light 60 generated by pumping light emitters 34b, has a plurality of light conducting fibers 28a, 28b, . . . , each light conducting fibers 28a, 28b, . . . being allocated on the input end to a pumping light emitter 34b (FIG. 5a. By the positioning of one behind another of pumping light emitters 34b in linear form, there advantageously comes about a corresponding positioning of one after another, or one next to another, of light conducting fibers 28a, 28b, . . . of light conducting device 28, whereby a configuration is implemented of the type of a flat ribbon cable.

As may be seen in FIG. 4a, single light conducting fibers 28a, 28b, . . . of light conducting device 28 are positioned on the output side in the same side by side order at coupling mirror 42 of laser device 26, so that a correspondingly linear or rectangular beam profile comes about for the pumping light, which is transmitted from single pumping light source 34 to laser device 26 through light conducting fibers 28a, 28b, . . . of light conducting device 28. Accordingly, laser beam 24 or laser impulse generated by laser device 26, as a result of the application of pumping light, also has a noncircular beam profile, but rather a linear or rectangular beam profile. If the design of the rectangular beam profile is appropriate, then, compared to the usual systems having a circular beam profile, the advantage arises that at least some components of laser beam 24 impinge on focusing optics 52 in those regions which are at a greater distance from the optical axis of focusing optics 52 than the edge regions of a circular beam profile in the usual systems.

As a result, the advantageous reduction in the focus diameter of laser beam 24 at ignition point ZP comes about, as was described before, and with that, a reliable ignition of the air/fuel mixture comes about in combustion chamber 14 of internal combustion engine 10 (FIG. 1).

Instead of the development of a flat ribbon cable by single light conducting device 28, light conducting fibers 28a, 28b, . . . may also assume the configuration of a round cable or other configurations, at least from section to section, and especially in regions that differ from their initial regions or end regions.

The use of a noncircular beam profile, according to the present invention, is appropriate both for a laser device 26 having a passive Q-switch 46 and also for laser devices that do not have such a passive Q-switch. That is why passive Q-switch 46 in FIGS. 4a, 4b is symbolized by a dashed line.

FIG. 5b shows an enlargement of the top view illustrated in FIG. 4a onto single pumping light source 34.

FIG. 5c shows a schematic cross section of a further specific embodiment of ignition device 27, according to the present invention, at the connecting area of light conducting fibers 28a, 28b, 28c to pumping light emitter 34b. As is clear from FIG. 5c, both light conducting fibers 28a, 28b, having a circular cross section, and light conducting fibers 28c, having an elliptical cross section may be used to form light conducting device 28. A combination of light conducting fibers 28a, 28b, 28c having different geometries or cross sectional shapes is also possible.

Moreover, according to the present invention, it is possible to allocate a single light conducting fiber to a plurality of pumping light emitters 34. For example, two pumping light emitters 34b are allocated to light conducting fiber 28a, and three pumping light emitters 34b are allocated to light conducting fiber 28c, while one pumping light emitter 34b is allocated to light conducting fiber 28b, as was described with reference to FIG. 5a.

In a further, very advantageous specific embodiment of the present invention illustrated in FIG. 5d, coupling optics 37 are provided, which may be implemented, for example, by a cylindrical lens, particularly a nonspherical cylindrical lens, and which compensates for a fast-axis divergence of pumping light emitter 34b by an appropriate bundling of the pumping light, so that a greater efficiency is obtained during the coupling of pumping light from pumping light emitter 34b into light conducting fibers 28a, 28b, . . . .

Beam profiles other than linear or rectangular beam profiles may also be achieved for pumping light 60, according to the present invention. This may be implemented, on the one hand, in that light conducting fibers 28a, 28b, . . . fed with pumping light on the input side are positioned at their output facing laser device 26 or coupling mirror 42, in a corresponding manner, relative to one another. For instance, an essentially rectangular pumping light profile 60a may be achieved in the manner illustrated in FIG. 6a, by the positioning of end regions 28a′, 28b′, . . . of light conducting fibers 28a, 28b, . . . .

A dumbbell-shaped pumping light profile 60b may be achieved, for instance, by the configuration of the end regions of light conducting fibers 28a, 28b, . . . illustrated in FIG. 6b.

Additional pumping light profiles, such as a circular pumping light profile 60c, compare FIG. 6c, are also achievable by a corresponding arrangement of the end regions of light fibers 28a, 28b, . . . of light conducting device 28.

In addition to the linear arrangement of pumping light emitters 34b in single pumping light source 34, other suitable arrangements, particularly an arrangement in a matrix shape, or the like, may also be provided.

In one additional advantageous further specific embodiment of the ignition device according to the present invention, it is provided that pumping light source 30 is directly allocated to laser-active solid 44 or laser device 26 at the input side, a plurality of pumping light emitters 34b being provided in turn; and these pumping light emitters 34b being positioned with respect to one another as a function of a specifiable beam profile for laser beam 24 and/or pumping light 60. This means that, instead of using a light conducting device 28, pumping light source 30 may be positioned directly next to laser device 26, the desired beam profile for pumping light 60 coming about by an appropriate arrangement of pumping light emitter 34b.

An additional advantageous specific embodiment of the present invention provides that noncircular beam profiles of laser beam 24 be generated in that output mirror 48 of laser device 26, compare FIG. 2, is developed to have transmission for laser light 24 that is nonuniformly distributed over its surface.

Besides the increased energy density at ignition point ZP, the present invention also makes possible the optimal utilization of the light-conducting cross section of light conducting fibers 28a, 28b, . . . by an appropriate allocation of single pumping light emitters 34b to light conducting fibers 28a, 28b, and, because the transformation of beam profiles is adjustable via the relative arrangement of light conducting fibers 28a, 28b, . . . with respect to one another, the optical shape converters that are required in the usual systems may also be omitted. The rectangular cross section of single pumping light source 34 as well as of laser device 26 overall simplify their production and assembly and enable more efficient cooling. In addition, combustion chamber window 58 (FIG. 2) may advantageously also be made rectangular, that is, in particular noncircular, and may accordingly also better dissipate heat to its surroundings.

Because of the abnormal beam profile used, according to the present invention, it is furthermore advantageously possible to reduce the focal diameter of laser beam 24 without, at the same time, providing costly separate arrangement for the expansion of the laser beam before focusing optics 52.

The principle according to the present invention is not limited to the use of ignition devices for internal combustion engines of motor vehicles, but may particularly also be used in stationary engines.

1-12. (canceled)

13. An ignition device for an internal combustion engine of a motor vehicle, comprising:
a laser device which has a laser-active solid and which generates a laser beam in a form of a laser pulse for eradiation into a combustion chamber, the laser beam having a beam profile that differs from circular; and
focusing optics to focus the laser beam.

14. The ignition device as recited in claim 13, further comprising:
a pumping light source to apply pumping light to the laser device, the pumping light being supplied to the laser device.

15. The ignition device as recited in claim 13, wherein the beam profile of at least one of the laser beam and the pumping light have at least one of a rectangular shape, a linear shape, an annular shape and a dumbbell shape.

16. The ignition device as recited in claim 13, further comprising:
a light conducting device adapted to supply the laser device with pumping light provided by a pumping light source, the light conducting device having a plurality of light conducting fibers.

17. The ignition device as recited in claim 16, wherein at least one of the light conducting fibers has a circular or an elliptical cross section.

18. The ignition device as recited in claim 16, wherein ends of the light conducting fibers allocated to the laser device are positioned with respect to one another as a function of a specifiable beam profile for at least one of the laser beam, and the pumping light.

19. The ignition device as recited in claim 16, wherein the light conducting fibers of the light conducting device are combined at least section-by-section to form at least one of a round cable and a flat ribbon cable.

20. The ignition device as recited in claim 13, further comprising:
a pumping light source having a plurality of pumping light emitters.

21. The ignition device as recited in claim 20, wherein at least one of the pumping light emitters, which couple their pumping light into the light conducting fiber, are allocated respectively to a light conducting fiber of a light conducting device for supplying the laser device with pumping light.

22. The ignition device as recited in claim 20, wherein the pumping light emitters are positioned linearly or in matrix form.

23. The ignition device as recited in claim 20, further comprising:
coupling optics to bundle the pumping light, the coupling optics including a cylinder lens.

24. The ignition device of claim 23, wherein the cylinder lens is nonspherical.

25. The ignition device as recited in claim 20, wherein the pumping light source is allocated directly, at an input side, to the laser device and to the laser-active solid, the pumping light source having a plurality of pumping light emitters, the pumping light emitters positioned with respect to one another as a function of a specifiable beam profile for at least one of the laser beam, and the pumping light.
